(19) United States
(12) Patent Application Publication
(10) Pub. No.: US 2005/0223825 A1
(43) Pub. Date: Oct. 13, 2005

(54) Method to prevent rotation of caliper tools and other pipeline tools

(76) Inventor: Theo Janssen, Meppen (DE)

Correspondence Address: MOSER, PATTERSON & SHERIDAN, L.L.P., 3040 POST OAK BOULEVARD, SUITE 1500, HOUSTON, TX, 77056-6582, US

(21) Appl. No.: 11/015,187

(22) Filed: Dec. 17, 2004

Related U.S. Application Data
(60) Provisional application No. 60/536,957, filed on Jan. 16, 2004.

(51) Int. Cl. G01M 19/00

(52) U.S. Cl. 73/865.8

(57) ABSTRACT

The present invention generally relates to an apparatus and a method of measuring various conditions of the pipeline. In one aspect, a method of using a tool in a pipeline is provided. The method includes placing the tool in the pipeline. The tool having a rotational control member constructed and arranged to maintain the tool in a preselected rotational orientation relative to the pipeline. The method further includes urging the tool through the pipeline while maintaining the preselected rotational orientation. In another aspect, an apparatus for use in a pipeline is provided. The apparatus includes a body and at least one rotational control member disposed around the body and extending radially to the pipeline therearound. The rotational control member is capable of maintaining the body in a preselected rotational orientation relative to the pipeline. In yet another aspect, a measurement tool for use in a pipeline is provided.

### CROSS-REFERENCE TO RELATED APPLICATIONS

This application claims benefit of U.S. Provisional Patent Application Ser. No. 60/536,957, filed Jan. 16, 2004, which application is herein incorporated by reference in its entirety.

### BACKGROUND OF THE INVENTION

1. Field of the Invention

Embodiments of the present invention generally relate to an apparatus and a method for deriving data representative of the condition of a pipeline. More particularly, the invention relates to an apparatus and a method of preventing rotation of caliper tools and other pipeline tools in a pipeline.

2. Description of the Related Art

The safe and continuous operation of hydrocarbon pipeline networks is essential to the operators and users of such networks. Accordingly, such pipelines are cleaned and inspected at regular intervals to ensure their operational integrity.

The conventional approach to inspection of operating pipelines is for the pipeline to be precleaned several times using a “dumb” pig. The dumb pig operates to scrape and remove debris such as wax, scale, sand, and other foreign matter from the pipeline while maintaining fluid supply via the pipeline. In a newly laid pipeline, the interior of the pipeline typically does not contain as much foreign matter and therefore the step of precleaning may not be required. In either case, a detailed inspection is subsequently performed by an inspection pig, which makes detailed measurements of the pipeline to determine the internal condition of the pipe. The inspection pig is typically equipped with inspection technologies of varying sophistication. For instance, the inspection pig may include complex tools generally comprising arrays of probes and sensors and techniques such as magnetic flux leakage (MFL) or ultrasonic scanning (at various positions along the pipeline) to detect flaws or defects, which might prejudice the pipeline's integrity.

One shortcoming of conventional pigging pipeline inspection techniques is that once the defect in the pipe is detected, the data is recorded in the same manner regardless of the rotational orientation of the defect. For instance, if the defect is an interior protrusion in the pipeline, the inspection pig will record the depth of the protrusion and its location along the length of the pipeline. However, due to the constant rotational movement of the inspection pig while traveling through the pipeline, the rotational orientation of the protrusion is not indicated, that is whether the protrusion is at the top, bottom, or sides of the pipeline. Therefore, the exact circumferential location of the defect can not be easily determined from the data recorded by the inspection pig during the pigging operation.

Recently, an inertial device has been developed to measure the orientation of the inspection pig within the pipeline. More specifically, a gravitationally sensitive indicator disposed in the body of the inspection pig provides an electrical signal indicating the orientation of the inspection pig. The electrical signal along with other signals provides a means of indicating the position of the inspection pig relative to the vertical. However, these devices are complex and expensive.

A need therefore exists for a cost effective method and an apparatus for determining the condition of the pipeline by indicating the location and depth of a defect as well as the rotational orientation of the defect within the pipeline. There is a further need for a cost effective method and an apparatus for maintaining a tool in a preselected rotational orientation relative to the pipeline as it is urged through the pipeline.

### SUMMARY OF THE INVENTION

The present invention generally relates to an apparatus and a method of measuring various conditions of the pipeline. In one aspect, a method of using a tool in a pipeline is provided. The method includes placing the tool in the pipeline. The tool having a rotational control member constructed and arranged to maintain the tool in a preselected rotational orientation relative to the pipeline. The method further includes urging the tool through the pipeline while maintaining the preselected rotational orientation.

In another aspect, an apparatus for use in a pipeline is provided. The apparatus includes a body and at least one rotational control member disposed around the body and extending radially to the pipeline therearound. The rotational control member is capable of maintaining the body in a preselected rotational orientation relative to the pipeline.

In yet another aspect, a measurement tool for use in a pipeline is provided. The measurement tool includes a body and at least one flow cup disposed around the body and extending radially to the pipeline therearound. The at least one flow cup is constructed and arranged to maintain the body in a preselected rotational orientation relative to the pipeline. The measurement tool further includes at least one sensing member configurable for collecting data regarding an interior surface of the pipeline.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 is a cross-sectional view of one embodiment of a pipeline tool of the present invention in a pipeline.

FIG. 2 is a partial exploded view illustrating the various components of the pipeline tool.

### DETAILED DESCRIPTION OF THE PREFERRED EMBODIMENT

In general, there is provided an apparatus for, and method of, preventing rotation of a pipeline tool. Generally, a caliper tool is a pipeline tool for detecting the physical condition of a pipeline by obtaining data along the entire length of the pipeline, wherein the data is representative of the physical condition. However, as defined herein, the caliper tool may pertain to any measurement tool having a body and a flow cup, wherein the measurement tool is movable through a pipeline. It will be appreciated that the term “condition” with respect to a pipeline, may embrace a variety of different and independent pipeline factors such as debris deposits, protrusions, joints, bends, etc., the combination of which will provide an overall pipeline condition profile. To better understand the novelty of the apparatus of the present invention and the methods of use thereof, reference is hereafter made to the accompanying drawings.

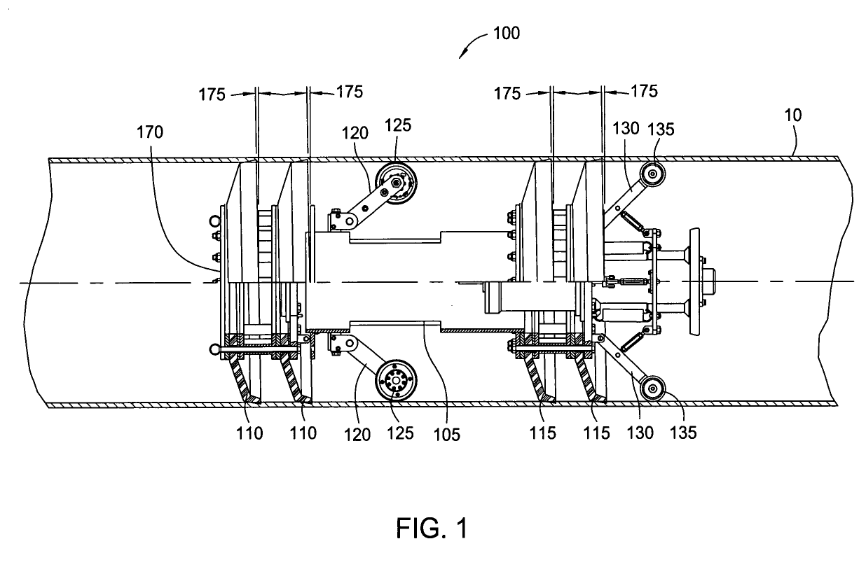

FIG. 1 is a cross-sectional view of one embodiment of a pipeline tool 100 of the present invention in a pipeline 10. For illustrative purposes, the pipeline tool 100 will be described hereafter as it relates to a pipeline pig. It should be understood, however, that the principles of the present invention may apply to any number of pipeline tools, such as intelligent tools.

The tool 100 generally includes a body 105 disposed between a pair of forward cups 110 and a pair of rear cups 115. The cups 110, 115 position the tool 100 centrally within the pipeline 10. Additionally, the cups 110, 115 act as rotational control members to maintain the rotational orientation of the tool 100. More specifically, the cups 110, 115 are offset at a preselected angle 175 relative to the vertical in order to maintain the tool 100 at a preselected rotational orientation as the tool 100 travels through the pipeline. In one embodiment, the preselected angle is 1 degree from the vertical. It should be understood, however, that the cups 110, 115 may be offset at any angle relative to the vertical without departing from principles of the present invention, such as an angle between 0.5 to 3 degrees. Furthermore, it should be understood that the cups 110, 115 may be arranged in a disk shape without departing from principles of the present invention, such as a disk in a typical “disk pig”.

Typically, the cups 110, 115 have a larger outer diameter than the inner diameter of the surrounding pipeline 10 and one of the cups 110, 115 and preferably the forward cups 110 are impermeable to fluid flow. Therefore, after the tool 100 is inserted into the pipeline 10, fluid flow acts against the cups 110, 115 and urges the tool 100 through the pipeline 10. The rear cups 115 may also be impermeable to fluid flow or the rear cups 115 may include a hole to allow fluid flow to act against the impermeable forward cups 110 to urge the tool 100 through the pipeline 10. The cups 110, 115 may be made from any type of material, such as polyurethane. As defined herein, the term fluid may comprise a liquid medium, a gaseous medium, a solid medium or combination thereof without departing from principles of the present invention.

The tool 100 further includes a computer assembly (not shown). The computer assembly is typically disposed in the body 105 for receiving and processing electronic signals generated by the tool 100. Generally, the computer assembly receives the electronic signals and stores data regarding the characteristics of the interior of the pipeline 10 as the tool 100 passes therethrough. The computer assembly may also include an electronic clock arrangement and other circuits for storage of data.

The tool 100 further includes a plurality of front arms 120 disposed adjacent the forward cups 110. Each front arm 120 is operatively attached to the body 105 and includes an odometer wheel 125 at an end thereof. The odometer wheel 125 is rotationally attached to the arm 120 to provide an electronic signal to the computer assembly to indicate the distance the tool 100 has traveled through the pipeline 10. The electronic signal is stored in the computer assembly which is subsequently used in conjunction with other electronic signals to indicate the condition of an interior surface of the pipeline 10. Although the tool 100 in FIG. 1 shows front arms 120 with two wheels 125 attached thereto, any number of wheels and arms may be employed without departing from principles of the present invention. Furthermore, the arms 120 and the wheels 125 may be positioned at any location along the tool 100 without departing from principles of the present invention.

The tool 100 further includes a plurality of rear arms 130 disposed adjacent the rear cups 115. The rear arms 130 are operatively attached to the body 105. Each arm 130 includes a roller member 135 disposed at an end thereof. The arms 130 are typically biased outward by a biasing member to allow the roller members 135 to contact the interior surface of the pipeline 10. As the tool 100 travels through the pipeline 10, the roller members 135 respond to changes in the configuration of the interior of the pipeline 10, such as dents, protrusions or bulges, and subsequently send an electronic signal to the computer assembly indicating the change in configuration. The electronic signal is stored in the computer assembly which is subsequently used in conjunction with other electronic signals, such as the electronic signal from the odometer wheels 125, to indicate the condition of the interior surface of the pipeline 10. Although the tool 100 in FIG. 1 shows two rear arms 130 with two roller members 135 attached thereto, any number of wheels and arms may be employed without departing from principles of the present invention. Furthermore, the arms 130 and the roller members 135 may be positioned at any location along the tool 100 without departing from principles of the present invention.

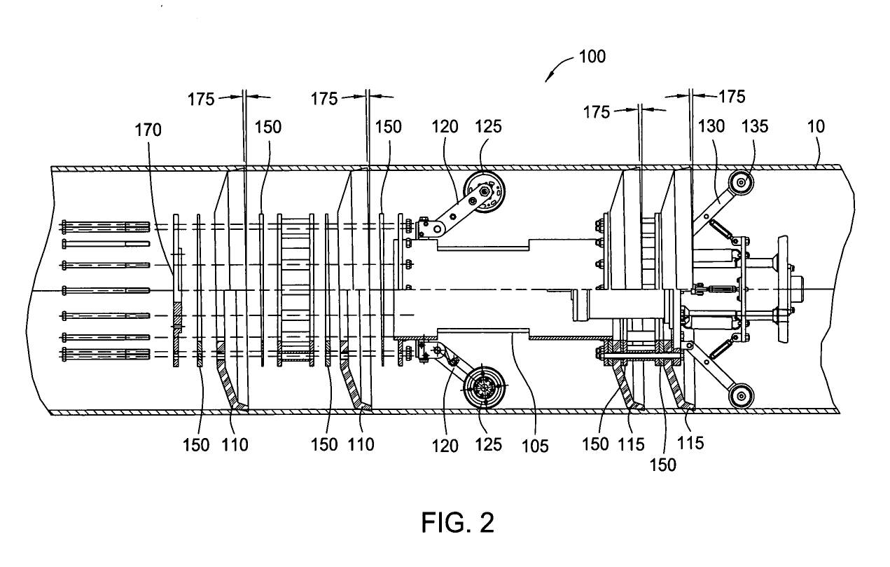

FIG. 2 is a partial exploded view illustrating the various components of the pipeline tool 100. As shown, the tool 100 includes a plurality of orientation members 150 disposed adjacent the cups 110, 115. For clarity, the orientation members 150 will be discussed as they relate to the forward cups 110. However, it should be noted that the discussion of the orientation members 150 apply equally to the rear cups 115. The primary function of the orientation member 150 is to offset the cups 110 at the preselected angle 175. It should be understood, however, that the cups 110, 115 may be offset at the preselected angle 175 in any manner known in the art without departing from principles of the present invention, such as by altering the cups 110, 115 themselves. Furthermore, it is within the scope of the present invention that only a selected cup, such as the front cup 110 or the rear cup 115, is offset at the preselected angle 175.

Generally, the orientation member 150 is a ring member that is machined at a predetermined angle. In one embodiment, the predetermined angle is one degree. However, the predetermined angle (preselected angle 175) may be greater or less depending on the size of the tool 100. For instance, a smaller tool may require the predetermined angle (preselected angle 175) of two or three degrees because of smaller diameter cups and the requirement of a minimum axial distance from the top edge of the cup to the lower edge of the cup. In this respect, the predetermined angle may be any angle without departing from principles of the present invention. Further, in one embodiment, the orientation member 150 is made from a metallic material, such as aluminum.

The primary function of the orientation member 150 is to offset the cups 110 at the preselected angle 175. In turn, the cups 110 contact the interior surface of the pipeline 10 and maintain the tool 100 at the preselected rotational orientation relative to the pipeline 10 as the tool 100 travels therethrough. For instance, for illustrative purposes only, if the front arm 120 is at the twelve o'clock position when the tool 100 is in the preselected rotational orientation, the tool 100 will travel substantially along the entire length of the pipeline 10 with the front arm 120 in the twelve o'clock position. It is to be understood, however, that the tool 100 may be in any preselected rotational orientation without departing from principles of the present invention. The significance of maintaining the preselected rotational orientation of the tool 100 relative to the pipeline 10 is that the data recorded by the tool 100 will indicate the exact condition of the pipeline 10, such as the axial location, depth, and rotational orientation of the debris deposits, protrusions, joints, bends, and other characteristics.

In operation, the pipeline 10 is typically cleaned by a dumb pig (not shown) and thereafter a detailed inspection of the interior of the pipeline 10 is performed by the tool 100. Preferably, the tool 100 is introduced at one end of the pipeline 10 through a pig launcher (not shown). Within a short distance from the pig launcher, the tool 100 rotationally adjusts to a preselected rotational orientation (if not already in the preselected rotational orientation). Thereafter, the tool 100 maintains the preselected rotational orientation as it is urged through the pipeline 10 by fluid pressure acting on the cups 110, 115. In one embodiment, due to the offset of the cups 110, 115 at the preselected angle 175, the fluid pressure acting on an upper portion of the fluid cups 110, 115 causes a nose 170 of the tool 100 downward while the tool travels through the pipeline 10. The downward position of the nose 170 along with other forces, such as gravity and fluid forces, acts to counter the rotation of the tool 100 and causes the tool 100 to maintain the preselected rotational orientation relative to the pipeline 10. In another embodiment, the offset of the fluid cups 110, 115, at the preselected angle 175 in conjunction with the lower end interference fit between the oversized diameter cups 110, 115, and the inner diameter of the pipeline 10 acts to counter the rotation of the tool 100 and causes the tool 100 to maintain the preselected rotational orientation relative to the pipeline 10.

As the tool 100 travels through the pipeline, the tool detects various changes in the configuration of the pipeline 10. For example, the arm 130 and the roller member 135 are urged radially inward in response to a protrusion formed in the interior of the pipeline 10. The radial movement of the arm 130 and roller member 135 sends an electronic signal to the computer assembly indicating the change in configuration. The electronic signal is stored in the computer assembly which is subsequently used in conjunction with other electronic signals, such as the electronic signal from the odometer wheels 125, to indicate the condition of the interior surface of the pipeline 10.

After the tool 100 has traveled substantially the entire length of the pipeline 10 at the preselected rotational orientation while collecting data regarding the interior condition of the pipeline 10, the tool 100 is typically caught in a pig trap (not shown) and removed from the pipeline 10. Subsequently, the data relating to the condition of the pipeline 10 is downloaded from the computer assembly in the tool 100. The data contains many different aspects of the interior surface of the pipeline 10, for instance the location, depth, and the rotational orientation of the protrusion formed in the pipeline 10. This data is then used to determine a variety of different and independent pipeline factors such as debris deposits, protrusions, joints, and bends, the combination of which will provide an overall pipeline condition profile.

While the foregoing is directed to embodiments of the present invention, other and further embodiments of the invention may be devised without departing from the basic scope thereof, and the scope thereof is determined by the claims that follow.

1. A method of using a tool in a pipeline, comprising:
placing the tool in the pipeline, the tool having a rotational control member constructed and arranged to maintain the tool in a preselected rotational orientation relative to the pipeline; and
urging the tool through the pipeline while maintaining the preselected rotational orientation.

2. The method of claim 1, further including generating data indicating changes to a configuration of an interior surface of the pipeline as the tool is urged through the pipeline.

3. The method of claim 2, wherein the generated data includes the rotational orientation of the change to the configuration relative to the pipeline.

4. The method of claim 2, further including analyzing the data to determine the condition of the pipeline.

5. The method of claim 1, further including generating data representative of the position of the tool along the pipeline.

6. The method of claim 1, wherein the rotational control member comprises at least one flow cup extending radially to the pipeline therearound.

7. The method of claim 6, wherein the at least one flow cup is offset at a preselected angle relative to the vertical.

8. The method of claim 7, wherein the preselected angle is between 0.5 and 3 degrees.

9. An apparatus for use in a pipeline, comprising:
a body; and
at least one rotational control member disposed around the body and extending radially to the pipeline therearound, wherein the rotational control member is capable of maintaining the body in a preselected rotational orientation relative to the pipeline.

10. The apparatus of claim 9, wherein the at least one rotational control member is offset at a preselected angle relative to the vertical.

11. The apparatus of claim 10, wherein the preselected angle is between 0.5 and 3 degrees.

12. The apparatus of claim 10, wherein the preselected angle is 1 degree.

13. The apparatus of claim 9, further including a ring member machined at a predetermined angle.

14. The apparatus of claim 13, wherein the ring member is disposed adjacent the at least one rotational control member to offset the at least one rotational control member relative to the vertical.

15. The apparatus of claim 9, further including an odometer member capable of indicating the distance the apparatus has moved through the pipeline.

16. The apparatus of claim 9, further including a sensing member capable of indicating a change to a configuration of an interior surface of the pipeline.

17. The apparatus of claim 9, further including a computer assembly configurable to collect data sent by an odometer member and a sensing member.

18. The apparatus of claim 9, wherein the apparatus is a pipeline pig.

19. The apparatus of claim 9, wherein the rotational control member substantially restricts the apparatus from rotating while moving through the pipeline.

20. A measurement tool for use in a pipeline, comprising:
a body;
at least one flow cup disposed around the body and extending radially to the pipeline therearound, the at least one flow cup constructed and arranged to maintain the body in a preselected rotational orientation relative to the pipeline; and
at least one sensing member configurable for collecting data regarding an interior surface of the pipeline.
